(19) United States
(12) Patent Application Publication
(10) Pub. No.: US 2025/0076108 A1
(43) Pub. Date: Mar. 6, 2025

(54) High-Definition Broad-Band Visible-shortwave Infrared (SWIR) Sensors for Laser Detection

(71) Applicant: SWIR Vision Systems Inc., Durham, NC (US)

(72) Inventors: Jeffery Allan HILTON, JR., Durham, NC (US); Samuel J. WYMAN, Swanzey, NH (US); Robert B. STEWART, JR., Raleigh, NC (US); Christopher GREGORY, Chapel Hill, NC (US); Ethan J.D. KLEM, Chapel Hill, NC (US)

(21) Appl. No.: 18/648,897

(22) Filed: Apr. 29, 2024

Related U.S. Application Data
(60) Provisional application No. 63/498,968, filed on Apr. 28, 2023.

(51) Int. Cl. G01J 1/42; F41G 3/06; G01J 1/44

(52) U.S. Cl. CPC G01J 1/4257; G01J 1/44; F41G 3/065; G01J 2001/446

(57) ABSTRACT

A laser designation system is provided including a high-definition broad-band visible-shortwave infrared (SWIR) sensor. The SWIR sensor includes a colloidal quantum dot sensor operative across a spectral band of from about 400 nm to 2400 nm or any subset of wavelengths therein.

### CLAIM OF PRIORITY

This application claims the benefit of and priority to U.S. Provisional Application No. 63/498,968, filed Apr. 28, 2023, entitled High-Definition Broad Band Visible-SWIR Sensors for Laser Detection, the content of which is hereby incorporated herein by reference in its entirety.

### FIELD

The present inventive concept relates generally to sensors and, more particularly, to broad-band visible-Shortwave infrared (SWIR) sensors.

### BACKGROUND

Laser range finding, marking, targeting, and designating are now ubiquitous on the modern battlefield. The need for more covert and eye-safe systems is pushing system designers to look deeper into the infrared spectrum, shifting from the NIR to the SWIR and e-SWIR wavelengths. Indium Gallium Arsenide (InGaAs) field programmable arrays (FPAs) are being widely adopted in mounted systems that can afford the relatively high price points (e.g., tanks, aircraft, naval ships), but are generally cost prohibitive for unmounted troop-level systems like rifle scopes or extended reality (XR) headsets. As InGaAs detector fabrication becomes more commonplace overseas, the standard shortwave infrared (SWIR) wavelengths are also becoming less covert. SWIR sensors are a key component of modern-day laser designation and surveillance systems. However, improved systems are desired.

### SUMMARY

Some embodiments of the present inventive concept provide a laser designation system including a high-definition broad-band visible-shortwave infrared (SWIR) sensor. The SWIR sensor includes a colloidal quantum dot sensor operative across a spectral band of from about 400 nm to 2400 nm or any subset of wavelengths therein.

In further embodiments, the SWIR sensor may include asynchronous laser pulse detection and decoding capability.

In still further embodiments, the laser designation system may withstand military standard testing. Military standard testing determines and accredits whether the system is suitable for use in military applications.

In some embodiments, the laser designation system may be used for laser range finding, marking, targeting, and designating.

In further embodiments, the laser designation system may be used in unmounted troop-level systems like rifle scopes and/or extended reality (XR) headsets.

Related unmounted troop-level systems are also provided.

### BRIEF DESCRIPTION OF THE DRAWINGS

FIG. 1A is a diagram illustrating a high-speed test setup used to estimate rise and fall times of CQD® photodiode.

FIG. 1B is a diagram illustrating an Oscilloscope output of CQD® (bottom/solid) and Indium Gallium Arsenide (InGaAs) reference photodiode (top/dashed).

FIG. 2 is an image generated by an Acuros® 1.2 MP Image sensor after wire-bond, die attach, and 200C solder reflow cycle.

FIGS. 3A and 3B are graphs illustrating results of 85% RH/85C accelerated stress testing, percent quantum efficiency (QE) change (relative) as a function of stress time (FIG. 3A) and dark current values as a function of stress time (FIG. 3B).

FIGS. 4A and 4B are graphs illustrating results of 125° C. accelerated stress testing, percent QE change (relative) as a function of stress time (FIG. 4A) and dark current values as a function of stress time (FIG. 4B).

FIG. 5 is a graph illustrating spectral external quantum efficiency plots for existing CQDR Acuros® SWIR and eSWIR image sensors.

FIG. 6 is a diagram illustrating a general setup of a laser, target, and camera in accordance with some embodiments of the present inventive concept.

FIG. 7 is a diagram illustrating a visible image range captured from the position of the Acuros® camera and laser emitter.

FIGS. 8A and 8B illustrate an Acuros 1920 GigE 001 imaging 1.5 μm laser spot on NATO test target at 200 meters, full resolution raw image (FIG. 8A) and cropped image to highlight region of interest (FIG. 8B).

FIGS. 9A and 9B illustrate an Acuros 1920 GigE 001 imaging 1.5 μm laser spot on a NATO test target at 1000 meters, full resolution raw image (FIG. 9A) and cropped image to highlight region of interest (FIG. 9B).

FIGS. 10A and 10B illustrate an Acuros 1920 GigE 001 imaging 1.5 μm laser spot on a tank at 1800 meters, full resolution raw image (FIG. 10A) and cropped image to highlight region of interest (FIG. 10B).

FIGS. 11A and 11B illustrate an Acuros 1920 GigE 001 imaging 1.5 μm laser spot on a NATO test target at 2000 meters, full resolution raw image (FIG. 11A) and cropped image to highlight region of interest (FIG. 11B).

FIGS. 12A and 12B illustrate a comparison of CQD (FIG. 12A) and InGaAs (FIG. 12B) cameras imaging 200 m target.

FIGS. 13A and 13B are graphs illustrating QE Curves for existing commercial products (FIG. 13A) and enhanced QE design (FIG. 13B).

FIG. 14 is a simple block diagram of a laser detection system in accordance with some embodiments of the present inventive concept.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As used herein, the term “optoelectronic device” generally refers to any device that acts as an optical-to-electrical transducer or an electrical-to-optical transducer. Accordingly, the term “optoelectronic device” may refer to, for example, a photovoltaic (PV) device (e.g., a solar cell), a photodetector, a thermovoltaic cell, or electroluminescent (EL) devices such as light-emitting diodes (LEDs) and laser diodes (LDs). In a general sense, EL devices operate in the reverse of PV and photodetector devices. Electrons and holes are injected into the semiconductor region from the respective electrodes under the influence of an applied bias voltage. One of the semiconductor layers is selected for its light-emitting properties rather than light-absorbing properties. Radiative recombination of the injected electrons and holes causes the light emission in this layer. Many of the same types of materials employed in PV and photodetector devices may likewise be employed in EL devices, although layer thicknesses and other parameters must be adapted to achieve the different goal of the EL device.

As used herein, the term “quantum dot” or “QD” refers to a semiconductor nanocrystal material in which excitons are confined in all three spatial dimensions, as distinguished from quantum wires (quantum confinement in only two dimensions), quantum wells (quantum confinement in only one dimension), and bulk semiconductors (unconfined). Also, many optical, electrical and chemical properties of the quantum dot may be strongly dependent on its size, and hence such properties may be modified or tuned by controlling its size. A quantum dot may generally be characterized as a particle, the shape of which may be spheroidal, ellipsoidal, or other shape. The “size” of the quantum dot may refer to a dimension characteristic of its shape or an approximation of its shape, and thus may be a diameter, a major axis, a predominant length, etc. The size of a quantum dot is on the order of nanometers, i.e., generally ranging from 1.0-1000 nm, but more typically ranging from 1.0-100 nm, 1.0-20 nm or 1-10 nm. In a plurality or ensemble of quantum dots, the quantum dots may be characterized as having an average size. The size distribution of a plurality of quantum dots may or may not be monodisperse. The quantum dot may have a core-shell configuration, in which the core and the surrounding shell may have distinct compositions. The quantum dot may also include ligands attached to its outer surface or may be functionalized with other chemical moieties for a specific purpose.

Plasma synthesis has evolved to be one of the most popular gas-phase approaches for the production of quantum dots, especially those with covalent bonds. For example, silicon (Si) and germanium (Ge) quantum dots have been synthesized by using nonthermal plasma. The size, shape, surface and composition of quantum dots can all be controlled in nonthermal plasma. Doping that seems quite challenging for quantum dots has also been realized in plasma synthesis. Quantum dots synthesized by plasma are usually in the form of powder, for which surface modification may be carried out. This can lead to excellent dispersion of quantum dots in either organic solvents or water, i.e., colloidal quantum dots (CQD). Embodiments of the present inventive concept use CQD films as discussed below.

For purposes of the present disclosure, the spectral ranges or bands of electromagnetic radiation are generally taken as follows, with the understanding that adjacent spectral ranges or bands may be considered to overlap with each other to some degree: ultra-violate (UV) radiation may be considered as falling within the range of about 10-400 nm, although in practical applications (above vacuum) the range is about 200-400 nm. Visible radiation may be considered as falling within the range of about 380-760 nm. Infrared (IR) radiation may be considered as falling within the range of about 750-100,000 nm. IR radiation may also be considered in terms of sub-ranges, examples of which are as follows. Short wave infrared (SWIR) radiation may be considered as falling within the range of about 1,000-3,000 nm. Medium wave infrared (MWIR) radiation may be considered as falling within the range of about 3,000-5,000 nm. Long range infrared (LWIR) radiation may be considered as falling within the range of about 8,000-12,000 nm.

As discussed below, quantum dot photodiode (QDP) technology is implemented to provide low-cost nanotechnology-enabled photodetectors. In some implementations, the photodetectors may be configured to efficiently detect light with sensitivity spanning a spectral region ranging from about 250-2400 nm. Thus, the photodetectors may be configured as a multispectral device capable of producing images from incident ultraviolet (UV), visible and/or infrared (IR) electromagnetic radiation. In some implementations, the spectral range of sensitivity may extend down to X-ray energies and/or up to IR wavelengths longer than 2400 nm. The photodetectors as taught herein are cost effective, scalable to large-area arrays, and applicable to flexible substrates.

As used herein, “quantum efficiency” (QE) refers to the (absorption) quantum efficiency with the optimal efficiency being one. In the case of Quantum well infrared photodetectors (QWIPs), absorption takes place only if the electric field vector of the radiation has a component perpendicular to the QW layer planes, which necessitates the angle of incidence with respect to these planes being different from zero.

“Dark current” refers to the residual electric current flowing in a photoelectric device when there is no incident illumination. In physics and in electronic engineering, dark current is the relatively small electric current that flows through photosensitive devices such as a photomultiplier tube, photodiode, or charge-coupled device even when no photons are entering the device. The dark current generally consists of the charges generated in the detector when no outside radiation is entering the detector. It can be referred to as reverse bias leakage current in non-optical devices and is present in all diodes. Physically, on source dark current is due to the random generation of electrons and holes within the depletion region of the device.

As discussed in the background, shortwave infrared (SWIR) sensors are a key component of modern-day laser designation and surveillance systems that are used by, for example, the United States military. For example, SWIR sensors may allow a warfighter to covertly acquire and target adversaries with common infrared laser wavelengths including 1064 nm and 1550 nm. SWIR Vision Systems builds high-resolution sensors using colloidal quantum dot (CQD®) photodiodes sensitive across the spectral band from 400 to 2000 nm. CQD® technology provides the ability to image common designation lasers while simultaneously offering the benefits of high-pixel count imagers-including wide fields of view (FOV) and more pixels on target.

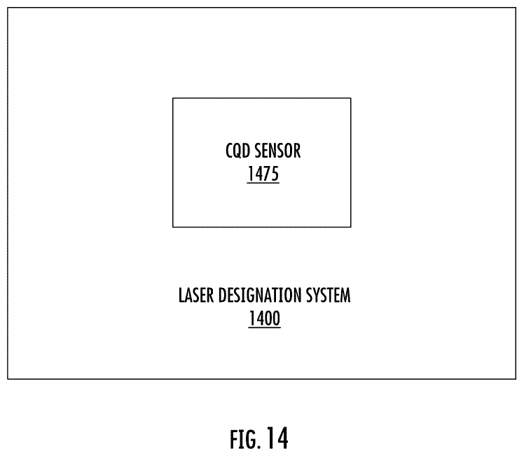

Referring to FIG. 14, a simple diagram illustrating a laser designation system in accordance with some embodiments of the present inventive concept. As illustrated in FIG. 14, the laser designation system 1400 includes one or more CQD sensors 1475. This laser designation system can be used in any product, application or system without departing from the scope of the present inventive concept. For example, the system may be included in unmounted troop-level systems, such as rifle scopes or extended reality (XR) headsets. However, embodiments are not limited to these examples.

To demonstrate the utility of the CQD® detector technology for these types of applications, i.e. laser detection systems, tests were performed imaging short pulse (<10 ns) 1064 nm lasers in outdoor environments using an Acuros® HD camera. These tests were carried out side-by-side with a commercially available Indium Gallium Arsenide (InGaAs) camera. Results of this testing and a comparison of the performance, range, and pulse-power requirements for designation applications using CQD® and InGaAs technology are discussed herein. As the importance of SWIR laser designation systems in the modern battlespace continues to grow, SWIR CQD® technology in accordance with some embodiments of the present inventive concept differentiate and maintain an advantage over conventional devices both with higher resolution imagery as well as the ability to detect wavelengths longer than what has traditionally been possible by traditional IR detector technologies.

SWIR Vision Systems' thin-film photodiode array technology uses a colloidal quantum dot (CQD®) broadband absorber with a band gap that can be tuned across the spectral range from the near-infrared (NIR) to the extended shortwave infrared (eSWIR). Today, SWIR Vision Systems produces cameras with visible (Vis)-SWIR response from 400 to 1650 nm and Vis-eSWIR cameras which are sensitive from 350 to 2100 nm. Owing to the power of parallel processing (i.e., monolithic process on 8 or 12″ Silicon complementary metal-oxide semiconductor (CMOS) readout integrated circuit (ROICs)), standard CMOS deposition and patterning techniques (e.g., sputter, evaporate, spin coat), and the mature colloidal quantum dots ccosystem for the Quantum dot LED (QLED) display market, the CQD® fabrication approach results in a straightforward path for fabricating SWIR and eSWIR Focal Plane Arrays (FPAs) at very high volumes and low cost.

Laser range finding, marking, targeting, and designating are now ubiquitous on the modern battlefield. The need for more covert and eye-safe systems is pushing system designers to look deeper into the infrared spectrum, shifting from the NIR to the SWIR and e-SWIR wavelengths. InGaAs FPAs are being widely adopted in mounted systems that can afford the relatively high price points (e.g., tanks, aircraft, naval ships), but are generally too expensive for unmounted troop-level systems like rifle scopes or XR headsets. As InGaAs detector fabrication becomes more commonplace overseas, the standard SWIR wavelengths are also becoming less covert. With its best-in-class uncooled signal-to-noise performance in the 1.7-2.0 μm range, the CQDR eSWIR detectors open another portion of the uncooled infrared spectrum. As discussed herein, using CQD® technology may be used to meet the need for size weight power and cost (SWaP-C) laser detection devices in the SWIR and eSWIR spectrum. SWAP-C refers to optimizing the size, weight, power and cost of a device or system.

The specific requirements for laser detection vary by application, but in general, the signal reflecting off of the objects of interest must exceed the sum of the noise sources (e.g. dark current, read noise, solar background, and the like), in many cases the detectors must be fast enough to extract some temporal information from the return signal (e.g. laser range finding, advanced laser phosphor display (ALPD) decoding), and in all cases, the devices must survive some level of military standard (MIL-STD) accelerated lifetime testing. The MIL-STD rating is a standard used by the United States military to determine and accredit whether equipment is suitable for use in military applications. Products that meet the MIL-STD ratings are said to be “military grade.”

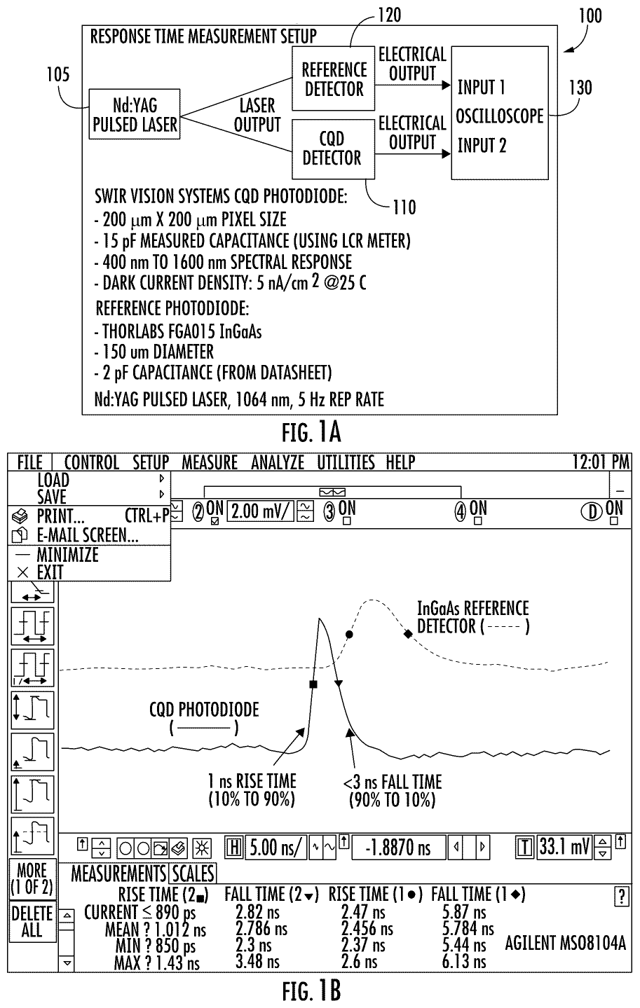

Referring to FIG. 1A, a diagram illustrating an example high-speed test setup 100 used to estimate rise and fall times of a CQD® photodiode versus a conventional system will be discussed. This set up was used to estimate the rise/fall time of the CQD® photodiode. As illustrated, the system 100 includes a pulsed laser 105, a reference detector 120, a CQD® detector 110 and an oscilloscope 130. In this example, the pulse laser 105 was a 5.0 Hz pulsed 1064 neodymium-doped yttrium aluminum garnet (Nd: YAG) laser. The CQD® detector/photodiode 110 has a 200 μm×200 μm pixel size; 15 pF measured capacitance (using an inductance (L) capacitance (C) resistance (R) (LCR) meter); a 400 nm to 1200 nm spectral response; and a dark current density of 5 nA/cm² @ 25° C. The reference photodiode 120 was a Thorlabs FGA015 InGaAs detector with a 150 μm diameter and a 2 pF capacitance. The oscilloscope was standard. It will be understood that the details of the elements of the system 100 of FIG. 1A are provided as an example only and embodiments of the present inventive concept are not limited thereto.

Nd: YAG lasers are one of the most common types of laser, and are used for many different applications. Nd: YAG lasers typically emit light with a wavelength of 1064 nm. In the miliary, Nd: YAG lasers may be used in laser designators and laser rangefinders.

As illustrated in FIG. 1A, during testing, the pulsed laser 105 was received/measured by both the CQDR detector 110 and the reference InGaAs detector 120. Each of the detectors 110 and 120 provide their corresponding electrical output to the oscilloscope 130. Using this setup 100, rise/fall times of less than 5 nanoseconds (ns) were measured on SWIR Vision Systems CQDR detectors 110. For laser range-finding applications as discussed herein, response times of 5 ns equate to 1.5 meters of spatial resolution, which exceeds the requirements for most long-range laser rangefinder (LRF) systems. An LRF is a device used to measure precise distances. ALPD systems typically operate at 20 Hz, which is many orders of magnitude below SWIR CQDR detectors' measured risc/fall times (InGaAs-FIG. 1B-dashed). CQD® detectors appear to have rise/fall times that significantly exceed the typical requirements for laser detection applications (CQD®-FIG. 1B solid). As illustrated in FIG. 1B, the CQD® photodiode experiences a 1.0 ns rise time from 10 to 90 percent and a less then 3.0 ns fall time from 90 to 10 percent.

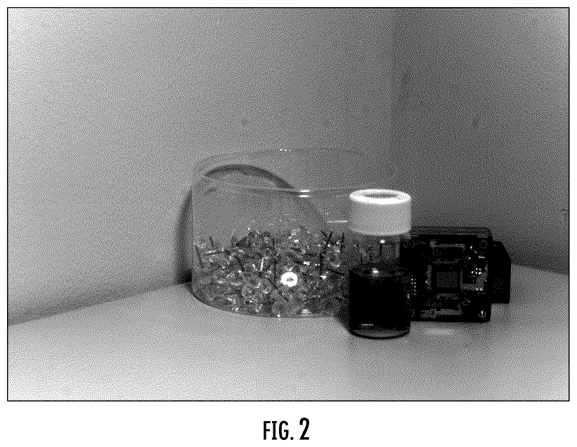

To increase the likelihood that laser detection systems will perform reliably in the field, these laser detection systems must survive thermal and mechanical MIL-STD accelerated stress tests. CQD® detectors generally do not rely on hybridization or any other novel mechanical connection or interface which would make them particularly sensitive to mechanical stresses. Vibration tests completed on the Acuros® camera suggest the wire bonds fail before any of the mechanical interfaces in the CQD® photodiode stack. To meet the typical MIL-STD requirements SWIR Vision Systems has optimized its CQD® detector technology to be compatible with long-established downstream packaging approaches (e.g., wire-bond, die-attach, solder reflow, color filter, etc.). A demonstration of this compatibility is illustrated in FIG. 2 wherein a 1.2 MP CQD® image sensor was subjected to a 200C solder reflow . . .

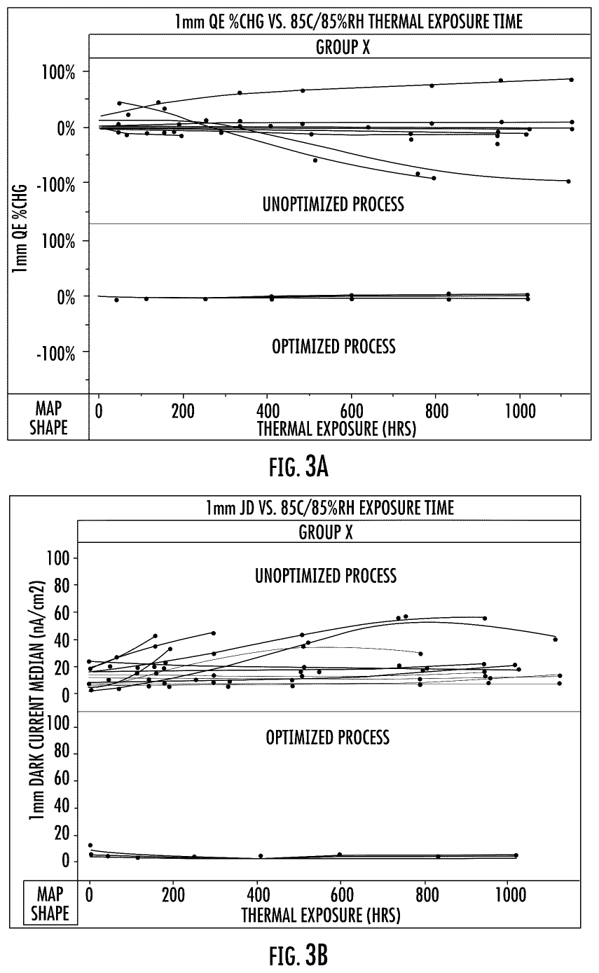

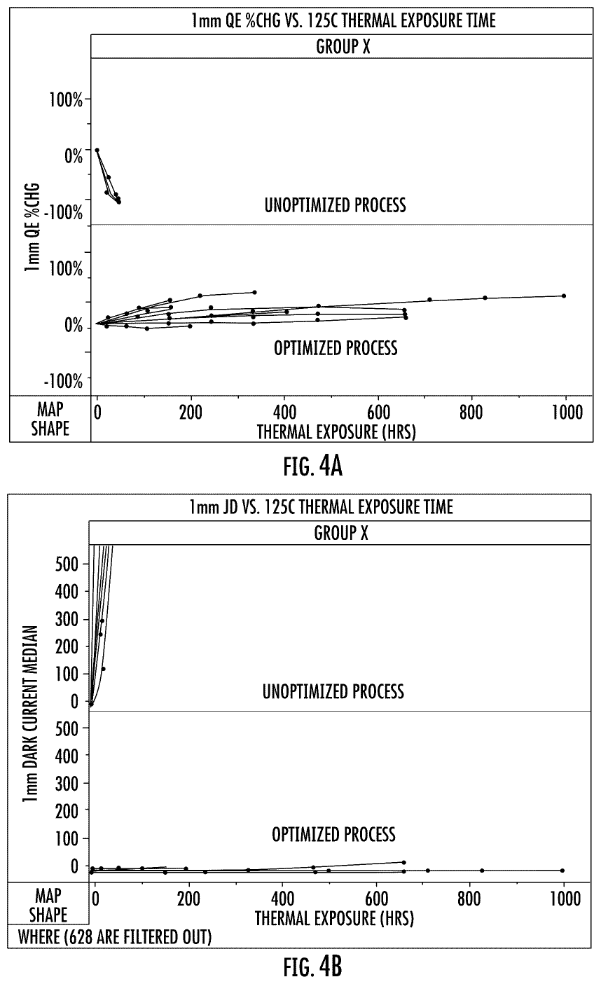

The thermal stability of the CQD® detectors has also been investigated. As illustrated in FIGS. 3A through 4B, after optimization of the fabrication process, the CQD® devices exhibited stable QE and dark current performance at both 85C/85% RH and 125° C. storage. The test simulates the devices' operating condition in an accelerated manner, and is primarily for device reliability evaluation.

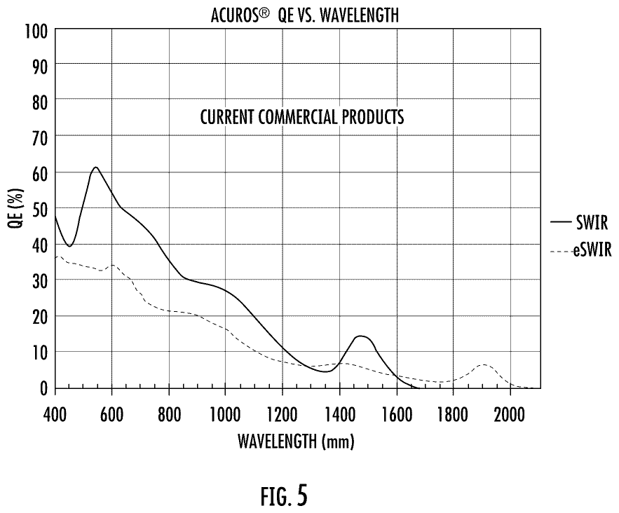

Signal-to-noise is another key requirement for laser detection applications. The CQD® detectors' read and dark current noise are similar to traditional InGaAs detectors, approximately 65e- for a 15 μm pixel in high gain mode and 5 nA/cm², respectively. However, the quantum efficiency of CQD® detectors in the current generation Acuros® cameras is significantly lower than typical InGaAs FPAs as illustrated in FIG. 5. Thus, the feasibility of these lower QE detectors in laser detection applications is explored herein.

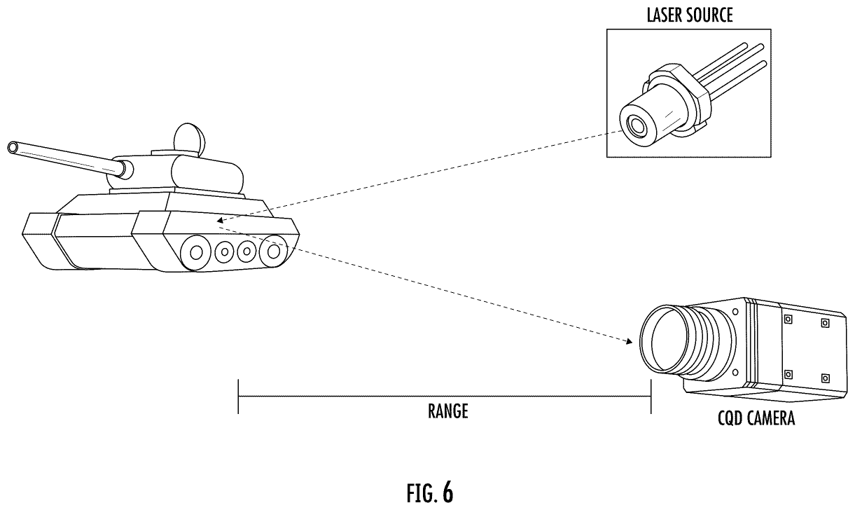

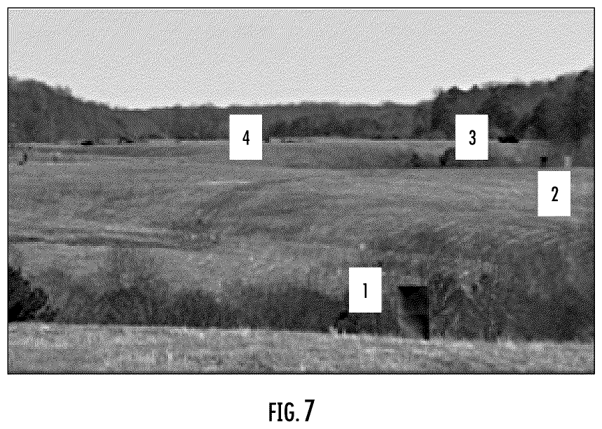

The demonstration described herein was carried out at a dedicated long-range laser detection test site. As illustrated in FIG. 6, a 1.5 μm laser emitter was co-located next to our CQDR Acuros® camera. The laser was pointed at various targets down range, e.g. 200 m, 1000 m 1800 m and 2000 m. The laser-emitted photons are reflected from the downrange targets back to the CQD® detector. Targets of various sizes, ranges, and reflectivities were imaged and are described in Table 1. The evaluation was done on a “cloudless” day with an air temperature of roughly 60° F. A 1.5 μm, 5 mJ laser range finder/marker at a repetition rate of 20 Hz was used as a photon source.

TABLE 1

| Target | Description | Range | Size | Reflectivity |
|---|---|---|---|---|
| 1 | NATO target | 200 m | 2.4 × 2.4 m | ~10% |
| 2 | NATO target | 1000 m | 2.4 × 2.4 m | ~10% |
| 3 | Tank | 1800 m | Tank | 30-40% |
| 4 | NATO target | 2000 m | 2.4 × 2.4 m | ~10% |

It will be understood that although various details about the tests are discussed herein, embodiments of the present inventive concept are not limited thereto.

Images were captured with a CQD® Acuros® 1920 GigE 001 camera. The camera contains a 1920×1080 format CQD® sensor made-up of 15×15 μm pixels. The existing ROIC in the Acuros® cameras does not have ALPD capability. In lieu of ALPD capability, a short exposure time of 0.5 ms was chosen to maximize the laser signal from the background solar signal. Using the external trigger feature, the camera was synchronized with the laser emitter, ensuring a single laser pulse fell within the 0.5 ms exposure time. To increase sensitivity, a high analog gain mode with a well-depth of 25Ke- was selected. A 100 mm f/2.1 SWIR optimized lens was used with a 1535 nm band-pass filter >60% peak transmission and 10 nm full-width half max. The onboard single-stage TEC inside the CQD® image sensor package was set to 10C.

For comparison purposes, a 640×512 resolution InGaAs camera with 15×15 μm pixels was used to collect side-by-side images. Exposure time (10 ms) and bandpass filter (1535 BP) which matched the Acuros® setup were chosen. An exact replicate of the lens was not available, so an 83 mm f/2.6 SWIR-coated lens was paired with the InGaAs camera. The InGaAs camera used for this experiment did have onboard ALPD capability.

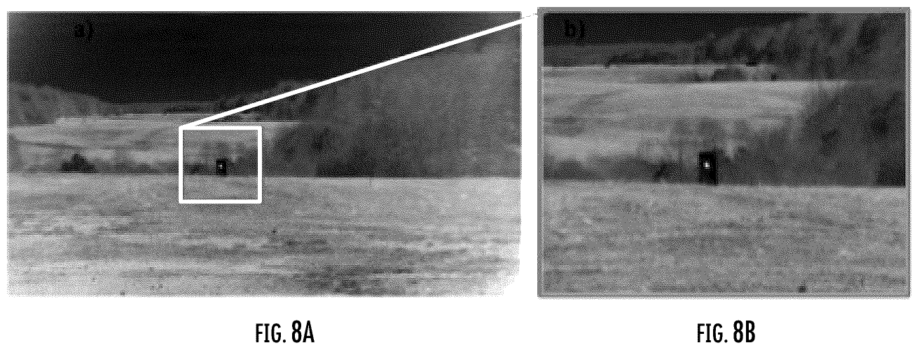

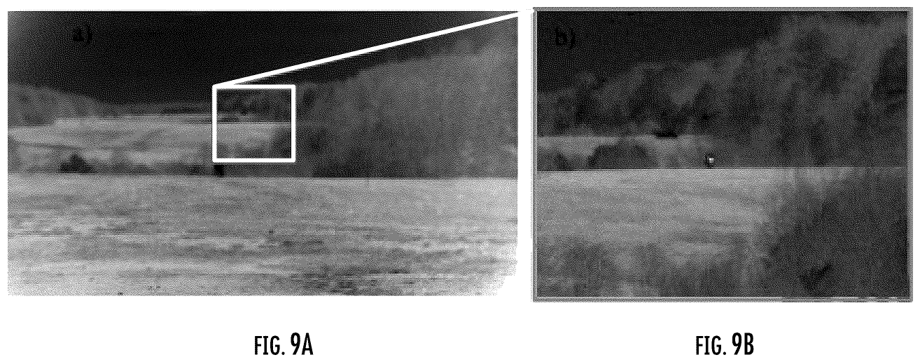

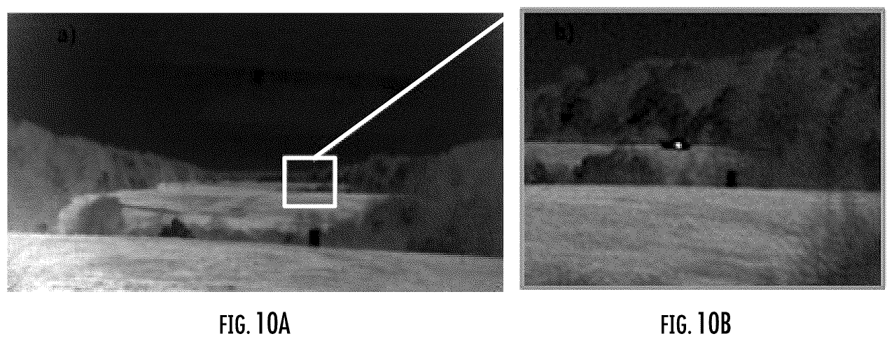

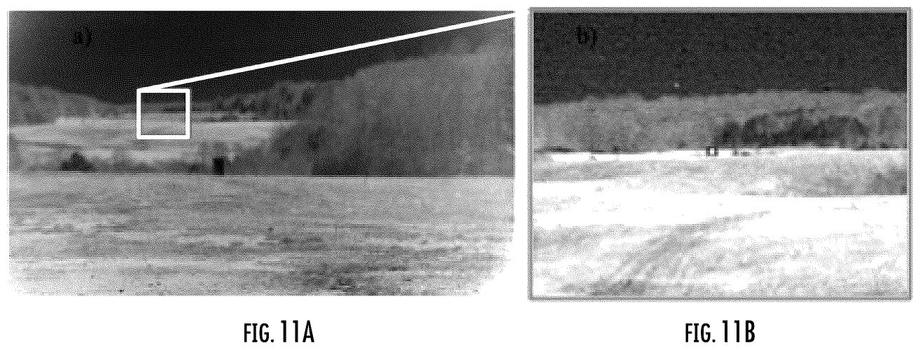

The Acuros® 1920 GigE 001 camera with onboard CQD® detector technology was able to detect the laser emitter at all ranges of interest, from 200 to 2,000 meters. Example images collected with the CQD® camera are illustrated in FIGS. 8A through 11B. Two images are shown at each range, one with the full 1920×1080 resolution (FIGS. 8A through 11A) and a cropped image to highlight the pixels on target (FIGS. 8B through 11B). Noise can be seen at the edges of the frame due to vignetting of the lens. Image quality could be further improved with the implementation of an optimized two-point non-uniformity correction algorithm.

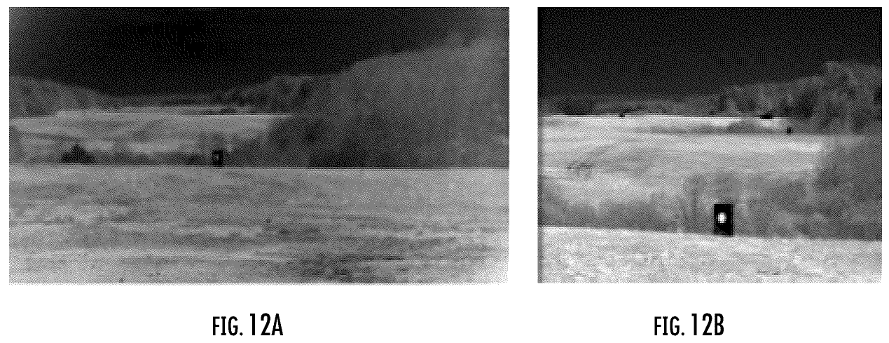

As illustrated in FIG. 12, comparison images were also collected with a 640×512 InGaAs camera. The InGaAs camera is equipped with an ALPD-capable ROIC. With ALPD capability, any pixel which detects an AC response, like a laser pulse, is assigned a value corresponding to saturation (e.g., 256 on an 8-bit scale). This “image processing” allows the laser-illuminated pixels to appear brighter than the surrounding scene. The InGaAs camera also implemented a 2-point optimized NUC to reduce fixed pattern noise.

One of the standout features of the CQD® camera is its industry-leading 2.1 MP resolution, enabling broader fields of view (FOV) and/or more pixels on target. In this demonstration, lenses of similar focal length (100 vs 83 mm) were chosen, resulting in a similar number of pixels on target. At a range of 200 m the 2.4×2.4 meter target the InGaAs camera had 4,444 pixels on target, compared to 6,400 of the Acuros® CQDR pixels. When using lenses of similar focal lengths, the FOV advantage of the 2.1 MP resolution is significant. At 2,000 m range, the 640×512 InGaAs sensor has a FOV of 23×18.5 mm or 0.4 km² while the 2.1 MP Acuros® camera has a FOV that is approximately 4.3× larger, 32.4×16.4 m. or 1.8 km². In accordance with embodiments discussed herein, larger FOVs would allow the user to locate the lasers on the field more quickly with greater situational awareness.

As discussed herein, the use of SWIR Vision Systems Acuros cameras, powered by its CQD® detector technology, to image laser spots at ranges of interest in arguably the most challenging environment, full sunlight is feasible. With its inherent ability to scale to much lower costs and smaller form factors, the CQD® detector technology appears to be well-positioned to address cost-sensitive laser spot applications like rifle and/or headset-mounted applications.

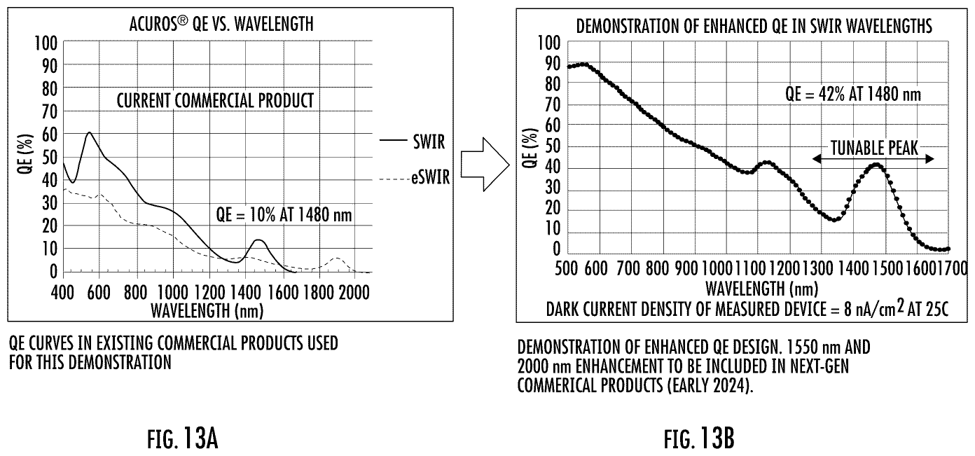

In some embodiments, the SWIR Vision Systems' detector may be implemented on ALPD-capable ROICs. The enhanced QE approach may be used to increase QE at wavelengths of interest by 2-4× without impacting noise. An example of the resulting QE curve from a 1480 nm enhanced device is illustrated, for example, in FIG. 13. The increased QE, and therefore SNR, will enable longer-range imaging and better performance in low-light conditions.

Embodiments of the present inventive concept are described herein with reference to cross-section illustrations that are schematic illustrations of idealized embodiments of the present inventive concept. As such, variations from the shapes of the illustrations as a result, for example, of manufacturing techniques and/or tolerances, are to be expected. Thus, embodiments of the present inventive concept should not be construed as limited to the particular shapes of regions illustrated herein but are to include deviations in shapes that result, for example, from manufacturing. For example, an implanted region illustrated as a rectangle will, typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the precise shape of a region of a device and are not intended to limit the scope of the present inventive concept.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Furthermore, although various layers, sections and regions of the photodetector may be discussed as being p-type and/or n-type, it is understood by those of skill in the art that in many devices these conductivity types may be switched without effecting the functionality of the device. If an element, region or layer is referred to as “n-type” this means that the element, layer or region has been doped to a certain concentration with n-type dopants, for example, Si, Germanium (Ge) or Oxygen. If an element region or layer is referred to “p-type” this means that the element, region or layer has been doped with p-type dopants, for example, magnesium (Mg), Beryllium (Be), Zinc (Zn), Calcium (Ca) or Carbon (C). In some embodiments, an element, region or layer may be discussed as “p⁺” or “n⁺,” which refers to a p-type or n-type element, region or layer having a higher doping concentration than the other p-type or n-type elements, regions or layers in the device. Finally, regions may be discussed as being epitaxial regions, implanted regions and the like. Although these regions may include the same material, the layer resulting from the various methods of formation may produce regions with different properties. In other words, an epitaxial grown region may have different properties than an implanted or deposited region of the same material.

In the specification, there have been disclosed embodiments of the inventive concept and, although specific terms are used, they are used in a generic and descriptive sense only and not for purposes of limitation. The following claim is provided to ensure that the present application meets all statutory requirements as a priority application in all jurisdictions and shall be construed as setting forth the scope of the present inventive concept.

What is claimed is:

1. A laser designation system comprising a high-definition broad-band visible-shortwave infrared (SWIR) sensor, the SWIR sensor including a colloidal quantum dot sensor operative across a spectral band of from about 400 nm to 2400 nm or any subset of wavelengths therein.

2. The laser designation system of claim 1, wherein the SWIR sensor includes asynchronous laser pulse detection and decoding capability.

3. The laser designation system of claim 1, wherein the laser designation system withstands military standard testing, wherein military standard testing determines and accredits whether the system is suitable for use in military applications.

4. The laser designation system of claim 1, wherein the laser designation system is used for Laser range finding, marking, targeting, and designating.

5. The laser designation system of claim 1, wherein the laser designation system is used in unmounted troop-level systems like rifle scopes and/or extended reality (XR) headsets.

6. An unmounted troop-level laser system comprising a laser designation system including a high-definition broad-band visible-shortwave infrared (SWIR) sensor, the SWIR sensor including a colloidal quantum dot sensor operative across a spectral band of from about 400 nm to 2400 nm or any subset of wavelengths therein.

7. The system of claim 6, wherein presence of the colloidal quantum dot sensor provides higher resolution imagery and detects wavelengths longer than conventional sensors.

8. The system of claim 6, wherein the system withstands military standard testing, wherein military standard testing determines and accredits whether the system is suitable for use in military applications.

9. The system of claim 6, wherein the system is used for Laser range finding, marking, targeting, and designating.

10. The system of claim 6, wherein the system is used in unmounted troop-level systems like rifle scopes and/or extended reality (XR) headsets.
